(19) United States
(12) Patent Application Publication
(10) Pub. No.: US 2015/0217697 A1
(43) Pub. Date: Aug. 6, 2015

(54) TRAVEL SAUCE DISPENSER

(71) Applicant: CP CONCEPTS, LLC, Petaluma, CA (US)

(72) Inventor: CURT JEROME PETERS, PETALUMA, CA (US)

(21) Appl. No.: 14/614,629

(22) Filed: Feb. 5, 2015

Related U.S. Application Data
(60) Provisional application No. 61/936,163, filed on Feb. 5, 2014.

(51) Int. Cl. B60R 7/06

(52) U.S. Cl. CPC B60R 7/06

(57) ABSTRACT

Apparatus for holding food items in a vehicle are disclosed. The apparatus include a mount for separably attaching to an air vent of a vehicle and for retaining a container. The apparatus can be used to temporarily hold items such as food condiments.

This application claims the benefit under 35 U.S.C. §119(e) of U.S. Provisional Application No. 61/936,163, filed on Feb. 5, 2014, which is incorporated by reference in its entirety.

### FIELD

The present invention relates to apparatus for holding food items using an air vent of a vehicle.

### BACKGROUND

Food such as fast food is often consumed in vehicles. Yet there is limited about of space and receptacles in a vehicle for holding various food items. Vehicles typically have retainers for holding liquids. However, foods often come with condiments such as ketchup, mustard, or other sauces. For example, French fires often come with ketchup. It can be inconvenient for a person to deal with the food and the condiments simultaneously.

Apparatus that improve the convenience of using condiments and sauces in a vehicle are desired.

### SUMMARY

Apparatus are disclosed that can be mounted to an air vent of a vehicle and attached to a container are disclosed. The container may hold a condiment or sauce.

In a first aspect, holders are disclosed comprising a container; and a mount comprising a first end configured to attach to the container and a second end configured to separably attach to a vehicle air vent louver.

### BRIEF DESCRIPTION OF THE DRAWINGS

FIGS. 1A1-1A5 show various views of a travel sauce dispenser according to certain embodiments.

FIGS. 1B1-1B5 show various views of a travel sauce dispenser according to certain embodiments.

FIGS. 1C1-1C5 show various views of a travel sauce dispenser according to certain embodiments.

FIGS. 1D1-1D4 show various views of a travel sauce dispenser according to certain embodiments.

FIGS. 2A-2F show various views of a travel sauce dispenser according to certain embodiments.

FIGS. 3A-3E show various views of a travel sauce dispenser according to certain embodiments.

FIG. 4 shows a photograph of an example of a container holding apparatus provided by the present disclosure.

Reference is now made to certain embodiments of methods and apparatus holding food items using an air vent of a vehicle. The disclosed embodiments are not intended to be limiting of the claims. To the contrary, the claims are intended to cover all alternatives, modifications, and equivalents.

### DETAILED DESCRIPTION

Apparatus provided by the present disclosure improve the convenience of using condiments and sauces in a vehicle.

Apparatus include a mount for separably connecting to a vent of a vehicle and a mount attached to a container. A mount can be configured to separably attach to an vehicle device. The mount can attach to a louver of an air vent or a vertical brace of an air vent. The mount can include a compressible handle that can be inserted between the louvers of an air vent and securely retain the apparatus.

The other end of the apparatus can be separably or fixedly attached to a container. The opposite end may include a ring in which a container may be place. The mount and the container may be attached as a single unit.

The container may include condiments or sauces.

A user eating, for example, French fries or other food, can dip the food into a condiment or sauce held in a container in a vehicle.

The disclosed apparatus provides a convenient way to securely hold condiments and sauces in a vehicle.

Certain embodiments of a travel sauce dispenser are shown in the figures.

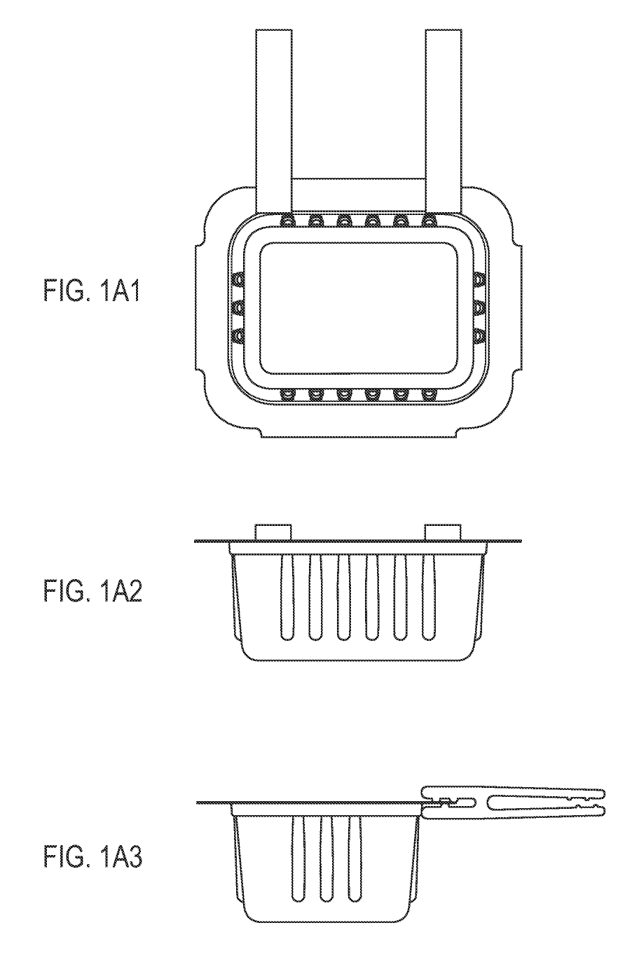

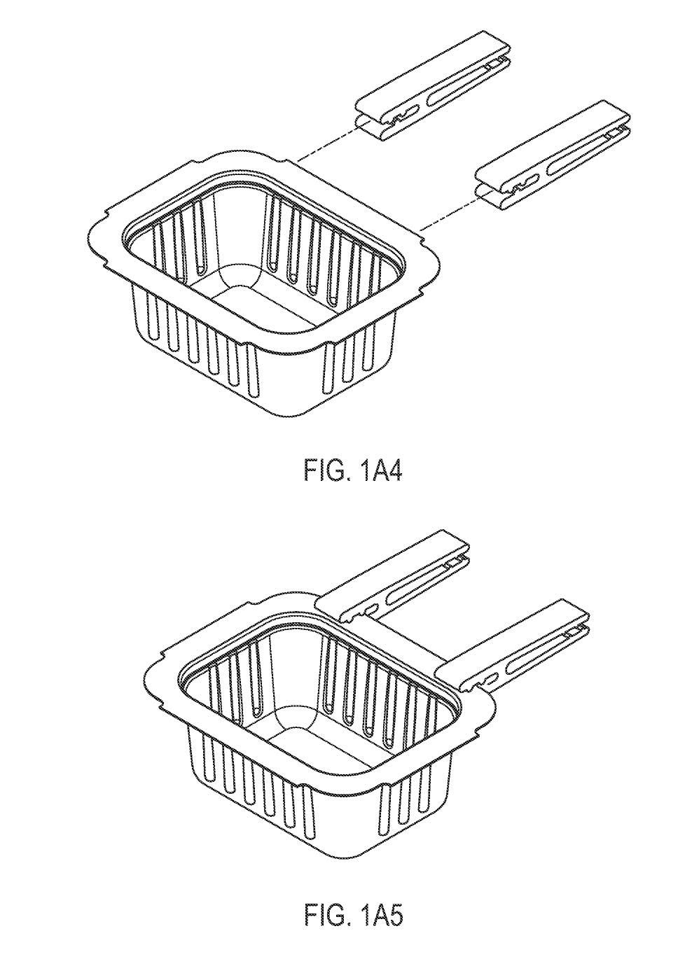

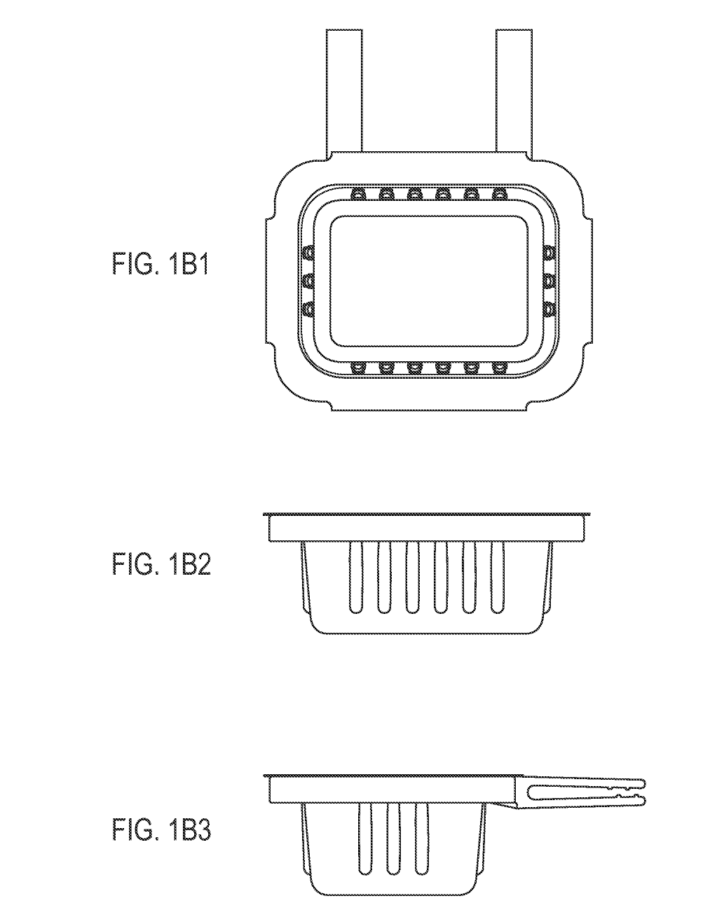

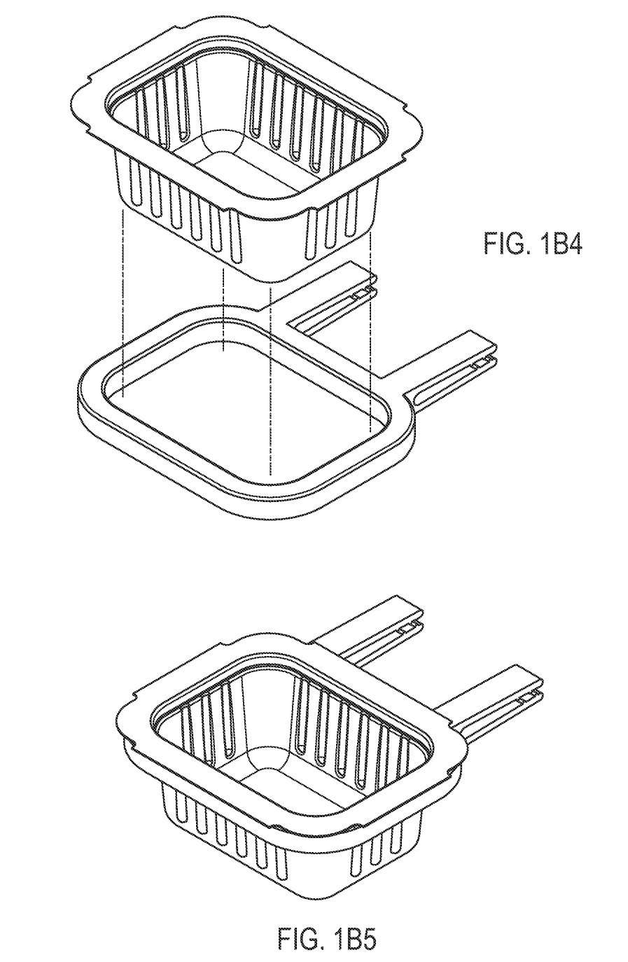

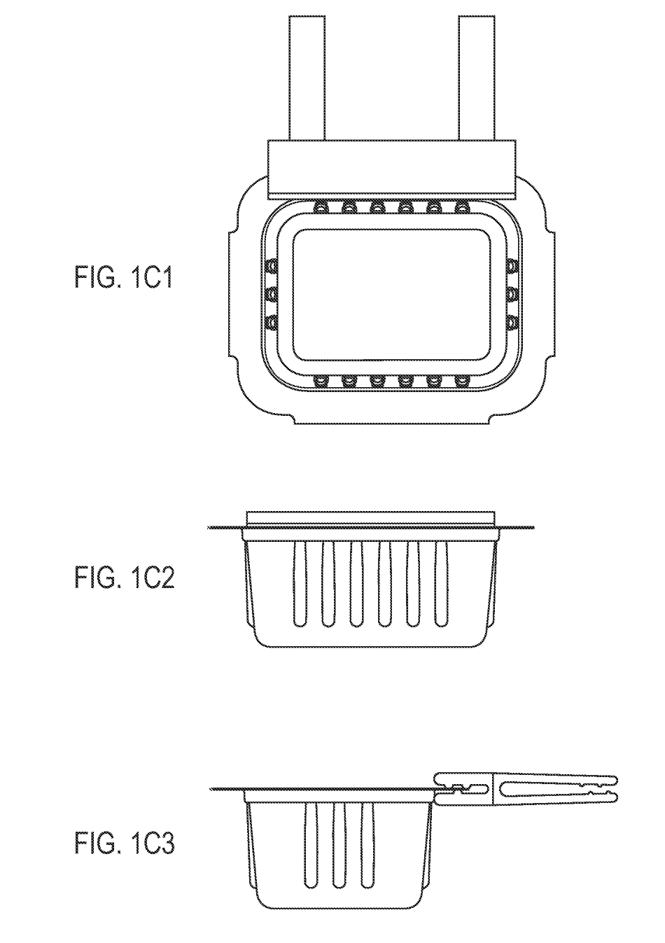

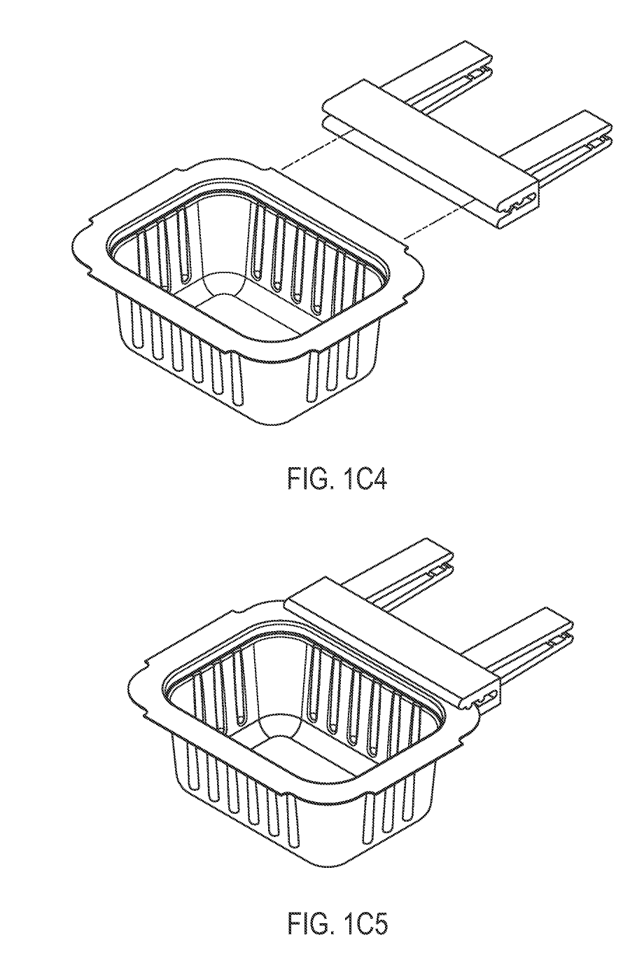

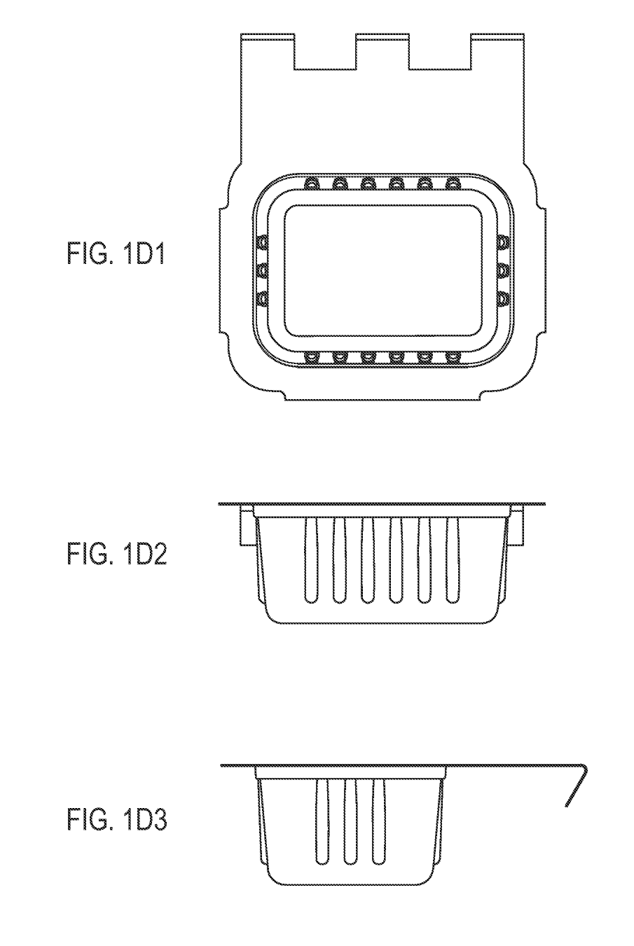

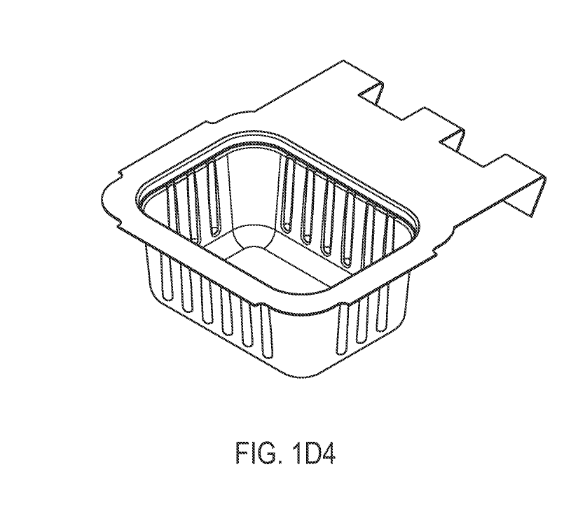

FIGS. 1A1-1A5 show views of a travel sauce dispenser with a container for holding a sauce, condiment, or other food a separate clip. The clip has two ends, one of which can be used to compressibly secure the container and the other end which can be used to compressibly secure to a vent louver. As shown, a rim on the container can slide into the clip having features configured to secure the lid. The other end of the clip can have similar features for retaining a vent louver. The clip is configured to slide into a vent louver and to securely retain the container during use.

FIGS. 1B1-1B5 show views of a travel sauce dispenser that includes clips for securing to a vent louver and mounted to a holder. The holder includes a rim that defines an opening in which a container can be inserted. The clips and holder can comprise a single part.

FIGS. 1C1-1C5 show views of a travel sauce dispenser comprising two separated clips configured to retain a vent louver and an elongated clip configured to retain a container. The separated clips and the elongated clip can be made of a single part. As shown, a rim of the container can be inserted into the elongated clip. Similarly, although not shown, the clip configured to couple with a vent louver can also be elongated to extend farther into the vent when engaged. The use of elongated clips can minimize bending of the travel sauce dispenser during use.

FIGS. 1D1-1D4 show views of a travel sauce dispenser that includes a bent arm configured to be inserted into a vent and retained by a vent louver. The dispenser also includes a holder having a rim that defines an opening for securing a container. In these embodiments, the retainer can be inserted into a vent and then pulled forward to engage the clip against a vent louver.

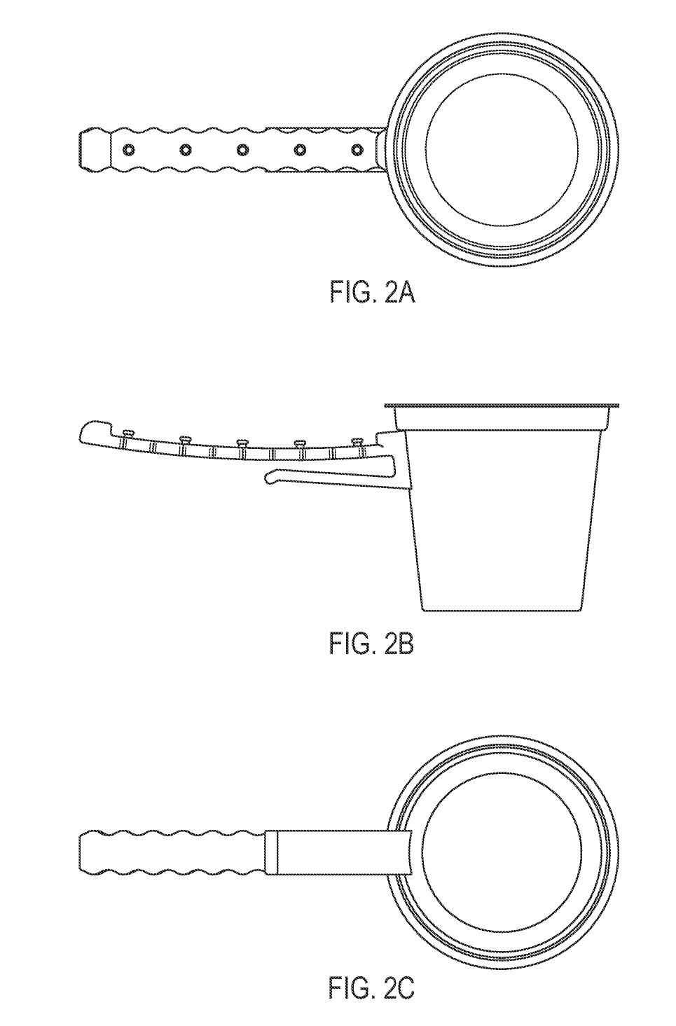

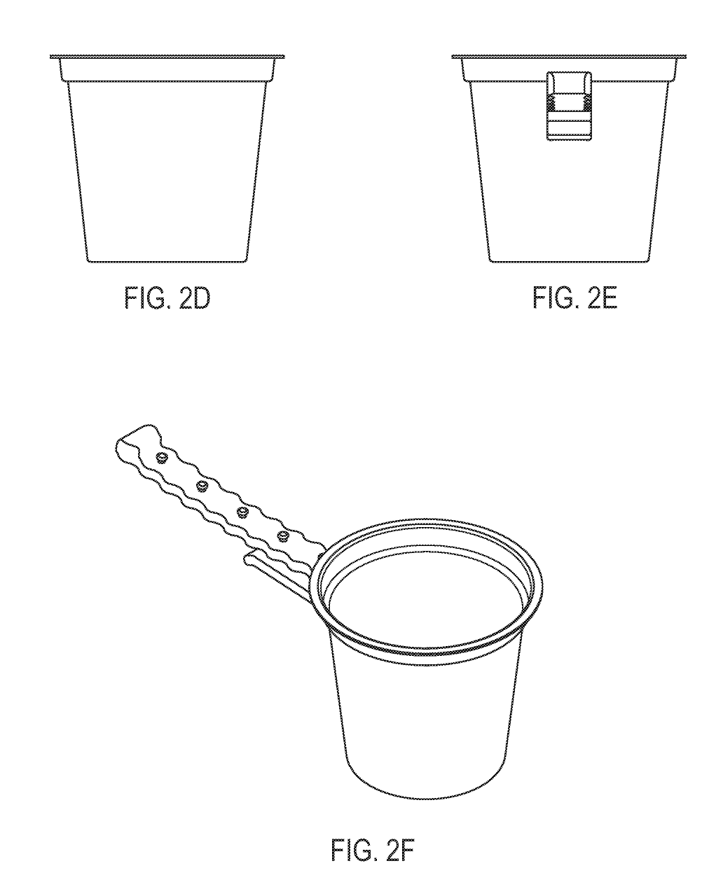

FIGS. 2A-2F show views of an embodiment of a travel sauce dispenser having a container and a slotted clip configured to retain a vent louver. The elongated portion of the clip is configured to provide stability to the dispenser during use.

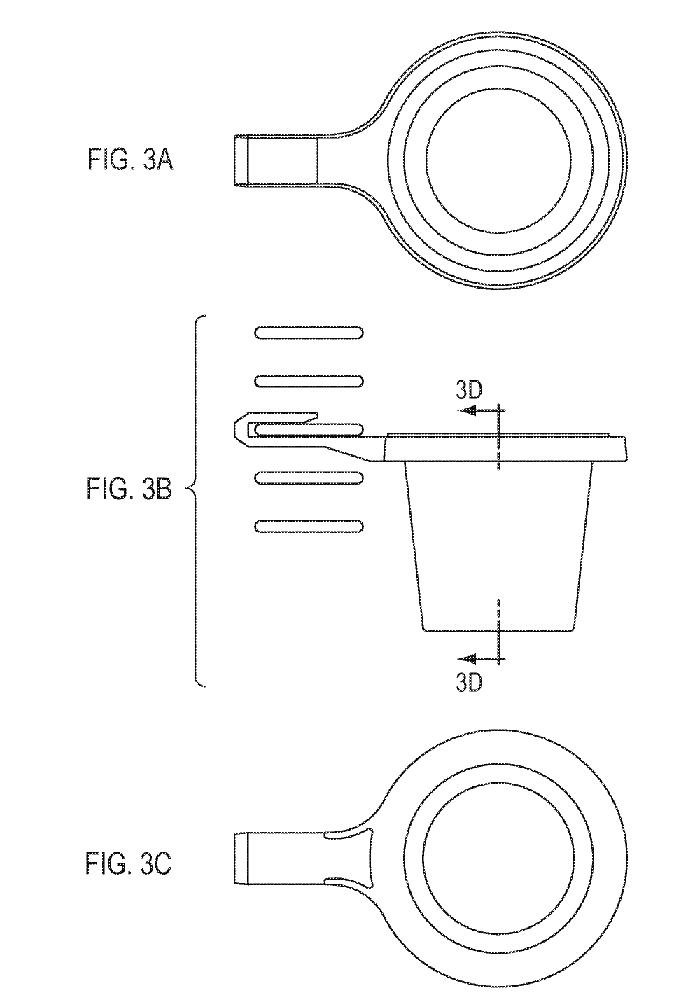

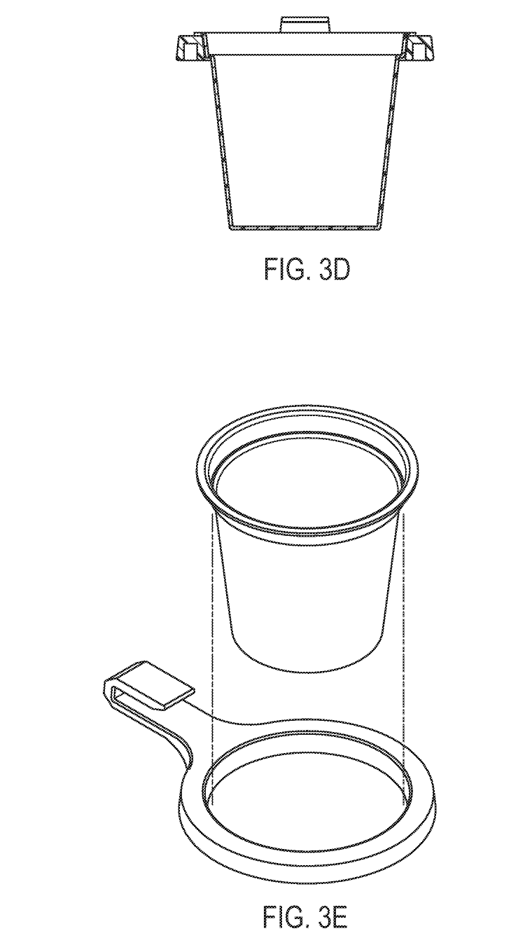

FIGS. 3A-3E show views of a travel sauce dispenser having a rim and a clip. The rim defines an opening into which a container can be inserted. The clip shown in FIGS. 3A-3E is U-shaped and is configured to be inserted into a vent and brought forward to engage a vent louver.

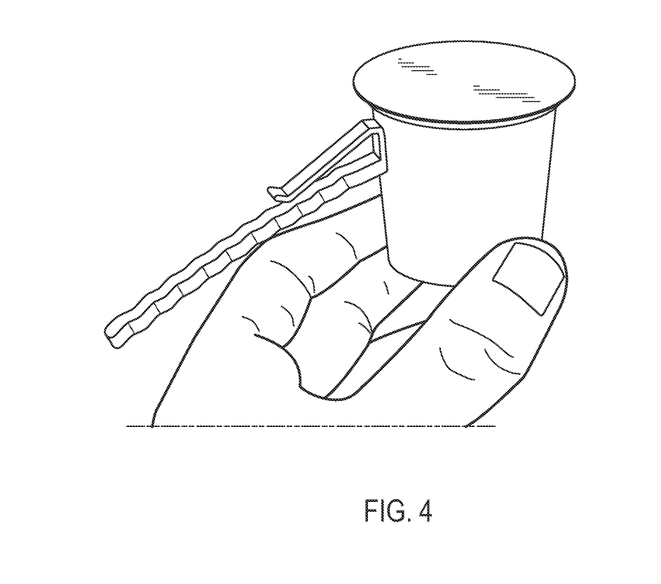

FIG. 4 is a photograph of an embodiment of a travel sauce dispenser shown in FIG. 2.

As can be appreciated, travel sauce dispensers can be configured to retain suitable sizes and shapes of containers. Furthermore, various clip designs may be used to couple the container or container holder to a vent louver. The clips can be configured to separably and securely couple to various size vent louvers such as vent louvers such as, for example, on automobiles, recreational vehicles and trucks.

A travel sauce dispenser can be made of any suitable material. For example, in certain embodiments, a travel sauce dispenser can be made from an injection molded thermoplastic.

In certain embodiments, a travel sauce dispenser may include a container as integral to the dispenser. In using such embodiments, a container would be filled with a sauce or condiments.

A rim of a travel sauce dispenser may be any suitable size. For example, a rim may be sized to hold typical containers provided at fast food outlets.

Finally, it should be noted that there are alternative ways of implementing the embodiments disclosed herein. Accordingly, the present embodiments are to be considered as illustrative and not restrictive. Furthermore, the claims are not to be limited to the details given herein, and are entitled their full scope and equivalents thereof.

What is claimed is:

1. A holder comprising:
a container; and
a mount comprising a first end configured to retain the container and a second end configured to separably attach to a vehicle air vent.

2. The holder of claim 1, wherein the first end is fixedly attached to the container.

3. The holder of claim 1, wherein the first end is separably attached to the container.

4. The holder of claim 1, wherein the second end comprises a clip.

5. The holder of claim 1, wherein the mount comprises two clips, wherein each of the two clips comprises:
a first end configured to slidably retain the container; and
and a second end configured to slidably attach to a vehicle air vent louver.

6. The holder of claim 1, wherein the mount comprises:
a rim that defines a cavity configured to retain the container; and
at least one clip connected to the rim, wherein the at least one clip is configured to slidably attach to a vehicle air vent louver.

7. The holder of claim 1, wherein the mount comprises:
a first end comprising an elongated clip, wherein the elongated clip is configured to slidably attached to a rim of the container; and
a second end comprising at least one clip configured to slidably attach to a vehicle air vent louver.

8. The holder of claim 1, wherein the mount comprises:
a rim that defines a cavity configured to retain the container; and
at least one clip connected to the rim, wherein the at least one clip is configured to be inserted into an air vent and is configured to slidably attach to the inside of an air vent louver.
